(19) United States
(12) Patent Application Publication
(10) Pub. No.: US 2013/0119822 A1
(43) Pub. Date: May 16, 2013

(54) MEMS DEVICE AND MANUFACTURING METHOD THEREOF

(71) Applicants: Jianhong Mao, Shanghai (CN); Fengqin Han, Shanghai (CN); Deming Tang, Shanghai (CN)

(72) Inventors: Jianhong Mao, Shanghai (CN); Fengqin Han, Shanghai (CN); Deming Tang, Shanghai (CN)

(73) Assignee: Lexvu Opto Microelectronics Technology (Shanghai) Ltd., Shanghai (CN)

(21) Appl. No.: 13/703,529

(22) PCT Filed: Dec. 13, 2010
(86) PCT No.: PCT/CN10/79714

§ 371 Date: Jan. 30, 2013

(30) Foreign Application Priority Data
Jun. 11, 2010 (CN) 201010200714.9

(51) Int. Cl. H02N 1/00

(52) U.S. Cl. CPC H02N 1/006
USPC 310/300; 427/58; 427/539; 427/535

(57) ABSTRACT

A Micro-Electro-Mechanical System (MEMS) device and its manufacturing method are provided. Said device comprises a MEMS component and said component comprises a main body (10) and a movable electrode (20). Said main body (10) contains a fixed electrode (110) and a cavity (30) and is covered by a first dielectric layer (400) which seals said cavity (30) into an enclosure. Said movable electrode (20) is connected with said main body (10) flexibly by a fixing piece and overhangs in said enclosure. Vias (405) are formed in said first dielectric layer (400) and filled with a second dielectric layer (500). The patent enables effective packaging for a MEMS device.

### CROSS REFERENCE TO RALATED APPLICATIONS

The present application claims the priority of Chinese Patent Application No. 201010200714.9, entitled “MEMS DEVICE AND MANUFACTURING METHOD THEREOF”, and filed on Jun. 11, 2010, the entire disclosure of which is incorporated herein by reference.

### FIELD OF THE DISCLOSURE

The invention relates to semiconductor manufacturing, and particularly relates to an MEMS apparatus and a method for manufacturing the same.

### BACKGROUND OF THE DISCLOSURE

MEMS (Microelectromechanical System) technology is popularly used to design, process, manufacture, measure and control micro/nanotechnology materials. MEMS (Microelectromechanical System) refers to a microsystem integrating mechanical parts, optical parts, driving parts and electrical parts, and is normally used in position sensor, rotating device or inertial sensor, such as acceleration sensor, gyroscope and sound sensor.

Since an MEMS device has a small size, normally at the micron level, even water vapor or very small particles like dust may cause damage to it. Therefore, MEMS devices need sealed encapsulation for working stability and high reliability under all kinds of environments. However, the various forms of MEMS devices lead to difficult implementation of sealed encapsulation. U.S. patent publication No. US2010127377 A1 discloses a method for MEMS device encapsulation.

Currently, there are two main sealed encapsulation processes for MEMS. The first process involves “fusion welding sealing cover”, which welds a cover directly to the substrate with molten solder. But required high temperature tends to produce undesirable thermodynamics effect in MEMS devices and peripheral control circuit. Moreover, flow of molten solder is hard to control, leading to contamination in MEMS devices. The second process involves “micromachining bonding sealing cover”, which seals the cover and the substrate by bonding technology. This process can be easily carried out and be fully compatible with conventional MEMS device manufacturing process, and thus is widely employed. However, a complete sealed encapsulation around leading wires can not be achieved.

Another conventional sealed encapsulation process for MEMS device is also proposed. A micro seal cover structure is etched on a glass sheet or a silicon slice for matching with an MEMS device and defines an opening in a bottom thereof. A groove is etched in a bottom of a wall of the micro seal cover. The MEMS device and an electrode are arranged on a substrate. An isolation layer is arranged at a bonding sealing area of the substrate around the MEMS device. A filler is arranged on the isolation layer or in the groove of the micro seal cover. The micro seal cover is bonded with the substrate in a manner that the groove is positioned on the isolation layer, forming a stuffed sealed cavity. The filler is positioned in the stuffed sealed cavity and heated till the filler is melted. Thus the micro seal cover seals MEMS device. The process reserves the plane wire leading technology, for suiting for integration manufacturing, and improves the sealing strength and performance.

However, the above process still needs the micro seal cover and the melted filler for sealing, which is complicated and has a risk of introducing undesirable thermodynamics effect in MEMS devices and peripheral control circuit.

Therefore, the conventional sealed encapsulation technology for MEMS device is still immature, and can not satisfy needs of air tight seal for MEMS device.

### BRIEF SUMMARY OF THE DISCLOSURE

A primary object of the invention is to provide an MEMS apparatus which achieves effective sealed encapsulation for MEMS devices.

Another object of the invention is to provide a method for manufacturing the MEMS apparatus.

In order to achieve the above object, the present invention provides an MEMS apparatus including an MEMS device. The MEMS device includes a main body containing a fixed electrode. A movable electrode is movably connected with the main body through a fixer and is movable relative to the fixed electrode. The main body defines a trench therein. The movable electrode is suspended in the trench. A first dielectric layer is located on the main body and above the trench and covers the trench for forming a sealed cavity. The movable electrode is suspended inside the sealed cavity through the fixer. Holes are defined through the first dielectric layer and are filled with a second dielectric layer.

Preferably, the main body includes a substrate, a first insulation layer located on the substrate, and a second insulation layer located on the first insulation layer. The trench extends through the first insulation layer and the second insulation layer.

Preferably, the movable electrode is formed of a material selected from Al, Ti, Cu, Co, Ni, Ta, Pt, Ag, Au or any combination thereof.

Preferably, the first dielectric layer, the second dielectric layer, the first insulation layer and the second insulation layer are formed of a material selected from silicon oxide, silicon nitride, silicon carbide, silicon oxynitride, carbon doped silicon oxynitride or any combination thereof.

Preferably, the holes in the first dielectric layer are arranged in a grid pattern.

Preferably, the second dielectric layer is formed of silicon oxide (SiO₂). Each hole in the first dielectric layer has an aperture of 0.2 μm˜1 μm and a depth-to-width ratio of 0.3˜0.5.

The present invention also provides a manufacturing method for the MEMS apparatus above, which includes following steps:

providing an MEMS device including a main body and a movable electrode. The main body defines a trench therein. A first sacrificial layer is located on a bottom of the trench. The movable electrode is located on the first sacrificial layer and is movably connected with the main body through a fixer;

forming a second sacrificial layer in the trench, the second sacrificial layer covering the movable electrode;

forming a first dielectric layer on the second sacrificial layer and on the main body. Holes are defined through the first dielectric layer for corresponding with the second sacrificial layer;

removing the first sacrificial layer and the second sacrificial layer through the holes; and

forming a second dielectric layer which fills the holes.

Preferably, a method for providing the MEMS device comprises:

providing a substrate;

forming a first insulation layer on the substrate, the first insulation layer having an opening exposing the substrate;

forming a first sacrificial layer filling the opening;

forming a movable electrode on the first sacrificial layer;

forming a second insulation layer on the first insulation layer;

forming a fixer which connects the movable electrode with the second insulation layer or connects the movable electrode with the substrate.

Preferably, the second dielectric layer is formed by chemical vapor deposition (CVD). The CVD is carried out under the conditions of (1) reaction gases: SiH₄, O₂ and N₂, wherein flow ratio of O₂ to SiH₄ is 3:1, (2) total flow rate of the reaction gases: 5 L/min˜20 L/min, (3) temperature: 250° C.˜450° C., and (4) normal pressure.

Preferably, a method of removing the first sacrificial layer and the second sacrificial layer is oxygen plasma ashing or nitrogen plasma ashing.

Compared to the prior art, the present invention has the benefits as follows:

The first dielectric layer and the second dielectric layer are formed above the movable electrode and on the main body of the MEMS device. The second dielectric layer is located inside the holes of the first dielectric layer. The first dielectric layer and the second dielectric layer, together with the main body, define a sealed cavity. The movable electrode which is vulnerable to dust and water vapor is enveloped inside the sealed cavity, and won't be affected by outside working environment. Therefore, the present invention achieves effective sealed encapsulation for MEMS devices by sealed encapsulation of movable electrode and working space, i.e. the sealed cavity.

### BRIEF DESCRIPTION OF THE DRAWINGS

FIG. 1 is a schematic cross sectional view of an MEMS apparatus;

FIG. 2 is a flow chart of a method for manufacturing MEMS apparatus; and

FIG. 3-FIG. 6 schematically illustrate the manufacturing method in FIG. 2.

### DETAILED DESCRIPTION OF THE DISCLOSURE

Based on the discussion of prior art, conventional sealed encapsulation processes have shortcomings, e.g., the first process fusion welding sealing cover, which welds a cover directly to the substrate with molten solder, tends to produce undesirable thermodynamics effect in MEMS devices and peripheral control circuit because of the high working temperature; the second process micromachining bonding sealing cover can not achieve a complete sealed encapsulation of cover and substrate around leading wires. The present invention provides an MEMS apparatus and a method for manufacturing the same, thereby achieving effective sealed encapsulation of MEMS device.

Hereunder the present invention will be described in detail with reference to embodiments, in conjunction with the accompanying drawings. It should be noted that the drawings in schematical views do not limit the extent of protection, which is defined by the patent claims of this invention.

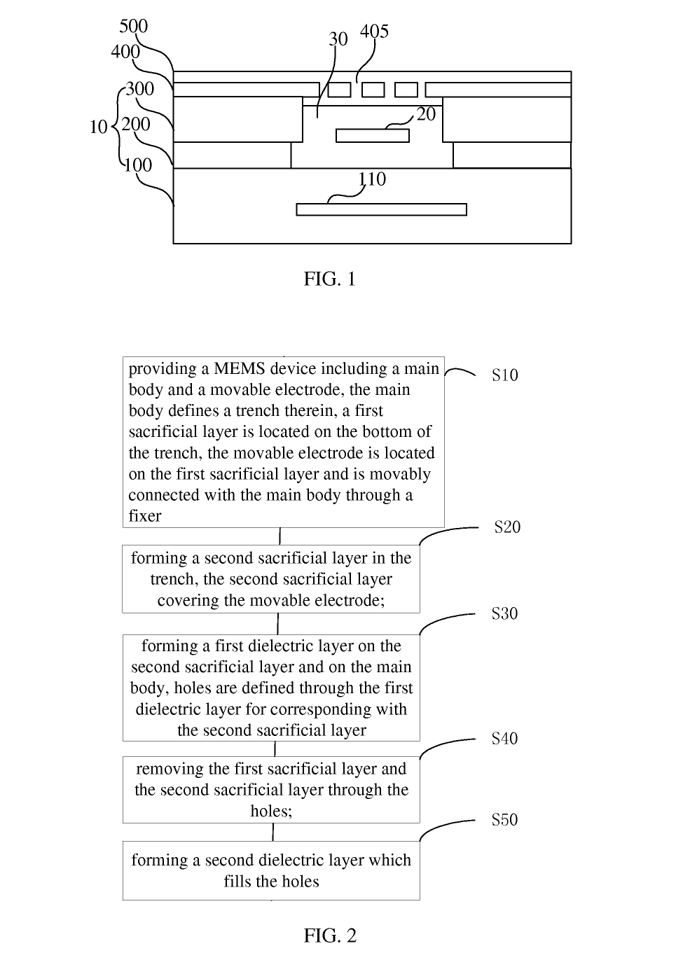

FIG. 1 schematically shows an MEMS apparatus in an embodiment. As shown in FIG. 1, an MEMS apparatus includes an MEMS device. The MEMS device includes a main body 10, and a movable electrode 20, movably connected with the main body 10 through a fixer (not shown). A fixed electrode 110 is provided inside the main body 10, and the movable electrode 20 is able to move relative to the fixed electrode 110. A trench 30 is defined in the main body 10, and the movable electrode 20 is suspended in the trench 30. A first dielectric layer 400 is located on the main body 10 and above the trench 30 and covers the trench 30 for forming a sealed cavity (not labeled). The movable electrode 20 is suspended inside the sealed cavity through the fixer (not shown). Holes 405 are defined through the first dielectric layer 400 above the trench 30, and are filled with a second dielectric layer 500. The sealed cavity is defined by the first dielectric layer 400, the second dielectric layer 500, and the trench 30 for serving as a working space of the movable electrode 20. The movable electrode 20 is able to move freely inside the working space, i.e. the sealed cavity. The first dielectric layer 400 has a thickness of 0.15 μm˜0.3 μm.

Referring to FIG. 1, in one embodiment, the main body 10 includes a substrate 100, a first insulation layer 200 located on the substrate 100, and a second insulation layer 300 located on the first insulation layer 200. The trench 30 extends through the first insulation layer 200 and the second insulation layer 300. The first dielectric layer 400 is located on the second insulation layer 300 and above the trench 30. The first dielectric layer 400, the second dielectric layer 500, the first insulation layer 200 and the second insulation layer 300 are formed of a material selected from silicon oxide, silicon nitride, or any combination thereof.

As shown in FIG. 1, in one embodiment, the holes 405 in the first dielectric layer 400 are arranged in a grid pattern. The second dielectric layer 500 is formed of SiO₂. The holes 405 in the first dielectric layer 400 have an aperture of 0.2 μm˜1 μm and a depth-to-width ratio of 0.3˜0.5. Besides filling the holes 405, the second dielectric layer 500 further contains a layer overlying the first dielectric layer 400. Alternative, the second dielectric layer 500 further contains a layer under the first dielectric layer 400 for wrapping the first dielectric layer 400. Impermeability of the sealed cavity is improved in this way.

The first dielectric layer 400, the second dielectric layer 500, the first insulation layer 200 and the second insulation layer 300 are formed of a material selected from silicon oxide, silicon nitride, silicon carbide, silicon oxynitride, carbon doped silicon oxynitride or any combination thereof. The fixed electrode 110 is formed of a material selected from Al, Ti, Cu, Co, Ni, Ta, Pt, Ag, Au or any combination thereof. The movable electrode 20 is formed of a material selected from Al, Ti, Cu, Co, Ni, Ta, Pt, Ag, Au or any combination thereof. The substrate is formed of Si or SiGe in monocrystalline, polycrystalline, or amorphous structure. The substrate can, alternatively, be a SOI, or other materials like indium antimonide, lead telluride, indium arsenide, indium phosphide, gallium arsenide, or gallium antimonide. Alternatively, the substrate further contains MOS devices.

The MEMS apparatus may have different structure according to the different MEMS devices therein. For example, if an MEMS device is used in an acceleration sensor, the movable electrode 20 is connected with the second insulation layer 300 through a fixer. Optionally, the fixer lies between the second insulation layer 300 and the movable electrode 20. The movable electrode 20 is able to move up and down inside the sealed cavity. Therefore, when the main body 10 moves, the movable electrode 20 stays still due to inertia. The acceleration of the main body 10 is acquired by measuring the capacitance of capacitor formed by the movable electrode 20 and the fixed electrode 110. If an MEMS device is used in a gyroscope, the movable electrode 20 is connected with the substrate 100 through a fixer. Optionally, the fixer connects the center of the movable electrode 20 and the substrate 100, and performs as a rotation axis. The movable electrode 20 is able to rotate around the rotation axis inside the sealed cavity. Therefore, when the main body 10 rotates, the movable electrode 20 stays still due to inertia. The rotating angular velocity of the main body 10 is acquired by measuring the capacitance of capacitor formed by the movable electrode 20 and the fixed electrode 110.

The first dielectric layer 400 and the second dielectric layer 500 seal the movable electrode 20 inside the sealed cavity which is created by the first dielectric layer 400, the second dielectric layer 500 and the main body 10. Therefore, the movable electrode 20 is not affected by the outside working environment, such as dust or water vapor, thus leading to high reliability of MEMS device.

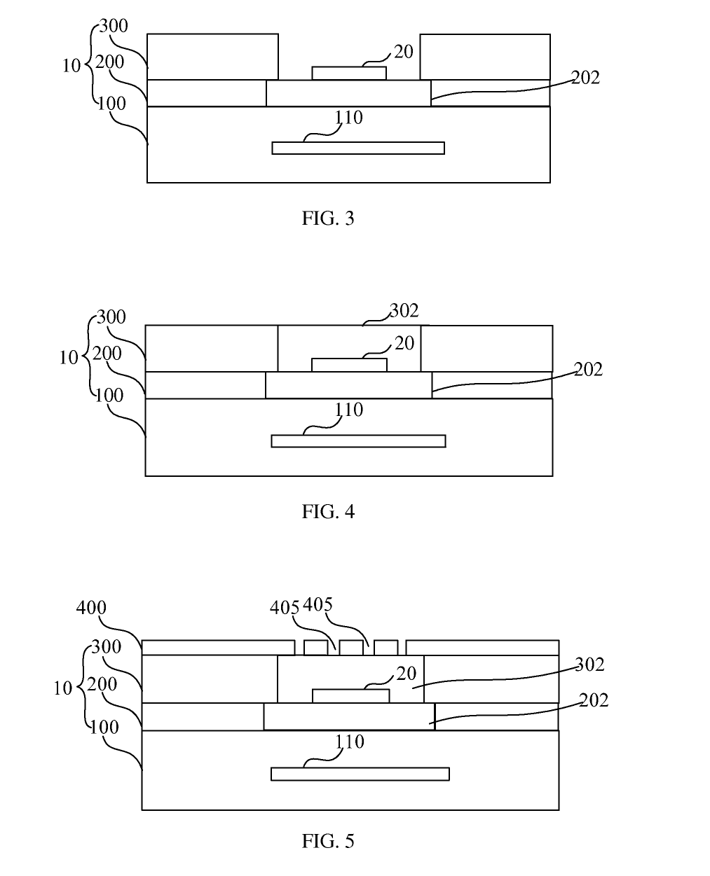

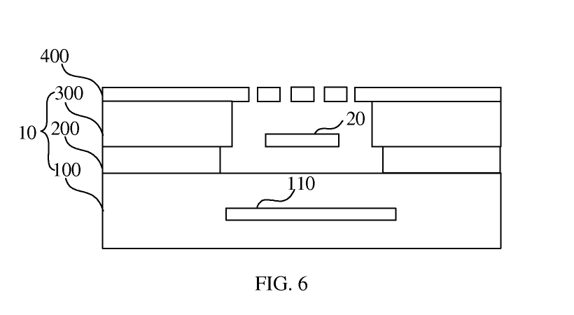

FIG. 2 is a flow chart of a manufacturing method of MEMS apparatus. FIG. 3 to FIG. 6 schematically show the manufacturing method in FIG. 2. Hereunder the manufacturing method of the MEMS apparatus in FIG. 1 will be described in detail with reference to the drawings from FIG. 2 to FIG. 6.

As shown in FIG. 2, the method for manufacturing MEMS apparatus includes the steps of:

S10, providing an MEMS device including a main body and a movable electrode. The main body defines a trench therein, a first sacrificial layer is located on the bottom of the trench, the movable electrode is located on the first sacrificial layer and movably connected with the main body through a fixer;

S20, forming a second sacrificial layer in the trench, the second sacrificial layer covering the movable electrode;

S30, forming a first dielectric layer on the second sacrificial layer and on the main body. Holes are defined through the first dielectric layer for corresponding with location of the second sacrificial layer;

S40, removing the first sacrificial layer and the second sacrificial layer through the holes;

S50, forming a second dielectric layer which fills the holes.

The above steps will be elaborated in detail below, with reference to FIG. 3˜FIG. 6.

In step S10, as shown in FIG. 3, providing an MEMS device including a main body 10 and a movable electrode 20. The main body 10 defines a trench 30 therein and can also contain a fixed electrode 110. A first sacrificial layer 202 is located on the bottom of the trench 30. The movable electrode 20 is located on the first sacrificial layer 202 and movably connected with the main body 10 through a fixer (not shown).

In one embodiment, in step S10, the MEMS device is manufactured by the steps including:

Providing a substrate 100. The substrate 100 is formed of Si or SiGe in monocrystalline, polycrystalline, or amorphous structure. The substrate 100 can also be a SOI, or contain other materials like indium antimonide, lead telluride, indium arsenide, indium phosphide, gallium arsenide, or gallium antimonide.

Forming a first insulation layer 200 on the substrate 100 by CVD (chemical vapor deposition) or PVD (physical vapor deposition). The first insulation layer 200 has an opening, where the trench 30 is located, for exposing the substrate 100.

Forming a first sacrificial layer 202 filling the opening by CVD or PVD. The material of the first sacrificial layer 202 can be carbon, germanium or polyamide. The material of the first sacrificial layer 202 in one embodiment is amorphous carbon, and the first sacrificial layer 202 is formed with PECVD (Plasma Enhanced Chemical Vapor Deposition) process under the conditions: temperature is 350° C.˜450° C. Atmospheric pressure is 1 torr˜20 torr. RF power is 800 W˜1500 W. Reaction gases are C₃H₆ and He. A flow rate of the reaction gases in 1000 sccm˜3000 sccm, in which C₃H₆/He flow ratio is ranged from 2:1 to 5:1.

Forming a movable electrode on the first sacrificial layer 202 by CVD or PVD process to deposit conductive materials on the first sacrificial layer 202 and the first insulation layer 200. The conductive materials can be Al, Ti, Cu, Co, Ni, Ta, Pt, Ag, Au or any combination thereof. A part of the conductive materials is retained above a center of the first sacrificial layer 202, while the other part of the conductive materials is removed by CMP (Chemical Mechanical Polish) or etching process.

Forming a second insulation layer 300 on the first insulation layer 200 by CVD or PVD. Then, a fixer (not shown) is formed for connecting the movable electrode 20 with the second insulation layer 300 or connecting the movable electrode 20 with the substrate 100. Structures and connections of the fixers may vary with different applications.

Then, as shown in FIG. 4, the current step is S20, which is forming a second sacrificial layer 302 covering the movable electrode 20 and the first sacrificial layer 202 by CVD or PVD process. The second sacrificial layer 302 in the trench 30 is level with the second insulation layer 300. Parts of the second sacrificial layer 302 overlying the second insulation layer 300 is removed by CMP. The material of the second sacrificial layer 302 can be carbon, germanium or polyamide. The material of the second sacrificial layer 302 in one embodiment is amorphous carbon, and the second sacrificial layer 302 is formed with PECVD (Plasma Enhanced Chemical Vapor Deposition) process under the conditions: temperature is 350° C.˜450° C., atmospheric pressure is 1 torr˜20 torr, RF power is 800 W˜1500 W, reaction gases are C₃H₆ and He, flow rate of the reaction gases in 1000 sccm˜3000 sccm, in which C₃H₆/He flow ratio is from 2:1 to 5:1.

Then, as shown in FIG. 5, step S30 is forming a first dielectric layer 400 on the second insulation layer 300 and the second sacrificial layer 302 by CVD or PVD process. The first dielectric layer 400 is etched by a mask process to form holes 405 in the first dielectric layer 400 corresponding with location of the second sacrificial layer 302. The holes 405 in the first dielectric layer 400 are arranged in a grid pattern, which leads to a better effect (more evenly removed) when removing the first sacrificial layer 202 and the second sacrificial layer 302. In one embodiment, a photomask with grid pattern is provided, photolithography is carried out to form patterned photoresist, and the first dielectric layer 400 is etched under the patterned photoresist.

In step S40 as shown in FIG. 6, the first sacrificial layer 202 and the second sacrificial layer 302 can be removed by cleaning or ashing through the holes 405. E.g. the ashing is oxygen plasma ashing or nitrogen plasma ashing. In one embodiment, the first sacrificial layer 202 and the second sacrificial layer 302 are made of dense activated carbon formed by CVD process. O₂ is used to remove the first sacrificial layer 202 and the second sacrificial layer 302 under temperature of 350° C.˜450° C. Under this temperature, the dense activated carbon is oxidized to carbon dioxide gas while intense combustion does not take place. The carbon dioxide gas is then emitted from the holes 405, thus removing the first sacrificial layer 202 and the second sacrificial layer 302 and leaving other parts unaffected.

In step S50 as shown in FIG. 1, a second dielectric layer 500 is formed by PVD or CVD to fill the holes 405. The second dielectric layer 500 is made of TEOS, FSG, SiON, Si₃N₄, or SiC. In one embodiment, the second dielectric layer 500 is made of TEOS. APCVD is carried out under the conditions: (1) reaction gases are SiH₄, O₂ and N₂, (2) total flow rate of the reaction gases is 5 L/min˜20 L/min, (3) O₂/SiH₄ flow ratio is 2:1-5:1, (4) temperature is 250° C.˜450° C., and (5) normal pressure.

The present invention forms the movable electrode 20 of the MEMS device inside the cavity generated by the first sacrificial layer 202 and the second sacrificial layer 302. The first sacrificial layer 202, the second sacrificial layer 302, and the movable electrode 20 are then sealed from the top by the first dielectric layer 400. The holes 405 are defined in the first dielectric layer 400, through which the first sacrificial layer 202 and the second sacrificial layer 302 are removed. At last, the second dielectric layer 500 is formed to fill the holes 405 in the first dielectric layer 400. The second dielectric layer 500 also seals the movable electrode 20 inside the sealed cavity which is formed by the substrate 100, the first insulation layer 200, the second insulation layer 300, the first dielectric layer 400 and the second dielectric layer 500. In this way, the present invention achieves sealed encapsulation of the movable electrode 20. The movable electrode 20 and the working space (i.e. sealed cavity) which is vulnerable to dust and water vapor are now inside this sealed cavity, and won't be affected by outside working environment.

Although the present invention has been illustrated and described with reference to the preferred embodiments of the present invention, those ordinary skilled in the art shall appreciate that various modifications in form and detail may be made without departing from the spirit and scope of the invention.

1. An MEMS apparatus including an MEMS device comprising:
a main body containing a fixed electrode; and
a movable electrode movably connected with the main body through a fixer and movable relative to the fixed electrode;
wherein the main body defines a trench therein, the movable electrode being suspended in the trench, a first dielectric layer being located on the main body and above the trench and covering the trench for forming a sealed cavity, the movable electrode being suspended inside the sealed cavity through the fixer, holes being defined through the first dielectric layer and filled with a second dielectric layer.

2. The MEMS apparatus as claimed in claim 1, wherein the main body includes a substrate, a first insulation layer located on the substrate, and a second insulation layer located on the first insulation layer, the trench extends through the first insulation layer and the second insulation layer.

3. The MEMS apparatus as claimed in claim 1, wherein the movable electrode is formed of a material selected from Al, Ti, Cu, Co, Ni, Ta, Pt, Ag, Au or any combination thereof.

4. The MEMS apparatus as claimed in claim 1, wherein the first dielectric layer, the second dielectric layer, the first insulation layer and the second insulation layer are formed of a material selected from silicon oxide, silicon nitride, silicon carbide, silicon oxynitride, carbon doped silicon oxynitride or any combination thereof.

5. The MEMS apparatus as claimed in claim 1, wherein the holes in the first dielectric layer are arranged in a grid pattern.

6. The MEMS apparatus as claimed in claim 5, wherein the second dielectric layer is formed of SiO2, the holes in the first dielectric layer have an aperture of 0.2 μm˜1 μm and a depth-to-width ratio of 0.3˜0.5.

7. A manufacturing method of an MEMS apparatus comprising:
providing an MEMS device including a main body and a movable electrode, wherein the main body defines a trench therein, a first sacrificial layer is located on the bottom of the trench, the movable electrode is located on the first sacrificial layer and movably connected with the main body through a fixer;
forming a second sacrificial layer in the trench, the second sacrificial layer covering the movable electrode;
forming a first dielectric layer on the second sacrificial layer and on the main body, wherein holes are defined through the first dielectric layer for corresponding with location of the second sacrificial layer;
removing the first sacrificial layer and the second sacrificial layer through the holes; and
forming a second dielectric layer which fills the holes.

8. The manufacturing method as claimed in claim 7, wherein the MEMS device is manufactured by the steps including:
providing a substrate;
forming a first insulation layer on the substrate, the first insulation layer having an opening exposing the substrate;
forming a first sacrificial layer filling the opening;
forming a movable electrode on the first sacrificial layer;
forming a second insulation layer on the first insulation layer; and
forming a fixer which connects the movable electrode with the second insulation layer or connects the movable electrode with the substrate.

9. The manufacturing method as claimed in claim 8, wherein the second dielectric layer is formed by chemical vapor deposition; the CVD is carried out under the conditions of, reaction gases: SiH4, O2 and N2, total flow rate of the reaction gases: 5 L/min˜20 L/min, O2/SiH4 flow ratio: 3, temperature: 250° C.˜450° C., and normal pressure.

10. The manufacturing method as claimed in claim 9, wherein a method of removing the first sacrificial layer and the second sacrificial layer is oxygen plasma ashing or nitrogen plasma ashing.

11. The manufacturing method as claimed in claim 7, wherein the movable electrode is formed of a material selected from Al, Ti, Cu, Co, Ni, Ta, Pt, Ag, Au or any combination thereof.

12. The manufacturing method as claimed in claim 7, wherein the first dielectric layer, the second dielectric layer, the first insulation layer and the second insulation layer are formed of a material selected from silicon oxide, silicon nitride, silicon carbide, silicon oxynitride, carbon doped silicon oxynitride or any combination thereof.

13. The manufacturing method as claimed in claim 7, wherein the holes in the first dielectric layer are arranged in a grid pattern.

14. The manufacturing method as claimed in claim 13, wherein the second dielectric layer is formed of SiO2, the holes in the first dielectric layer have an aperture of 0.2 μm˜1 μM and a depth-to-width ratio of 0.3˜0.5.
